(19) United States
(12) Patent Application Publication
(10) Pub. No.: US 2004/0054788 A1
(43) Pub. Date: Mar. 18, 2004

(54) Work center subscription web server

(76) Inventor: Norman Ken Ouchi, San Jose, CA (US)

Correspondence Address: N. K. OUCHI, 20248 VIEW CREST CT, SAN JOSE, CA, 95120, US

(21) Appl. No.: 10/232,925

(22) Filed: Aug. 31, 2002

(51) Int. Cl. G06F 17/60; G06F 15/16; G06F 12/14

(52) U.S. Cl. 709/229; 713/201

(57) ABSTRACT

The present invention is related to the control of services provided by devices attached to a network such as the Internet where multiple users use the device.

In the present invention, a shopfloor web service uses Internet devices at the work centers of a manufacturing line. Shopfloor operators can log into work centers using the Internet devices to operate the shopfloor web service. The present invention provides an authenticated association of Internet devices to work centers and control of the maximum number of concurrent active work centers and control of the maximum number of concurrent active operators. The control of maximum number of concurrent active work centers or operators can be used in subscription or license agreements from web service providers.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

The present invention is related to the control of services provided to devices attached to a network such as the Internet where multiple users use the device.

### BRIEF SUMMARY OF THE INVENTION

In the present invention, a shopfloor web service uses Internet devices at the work centers of a manufacturing line. Shopfloor operators can log into work centers using the Internet devices to operate the shopfloor web service. The present invention provides an authenticated association of Internet devices to work centers and control of the maximum number of concurrent active work centers and control of the maximum number of concurrent active operators. The control of maximum number of concurrent active work centers or operators can be used in subscription or license agreements from web service providers. The example of Internet devices as work centers in a shopfloor is to illustrate the present invention that can be applied to other applications where the relationship between the Internet device and the system object (such a work center) must be established.

### BACKGROUND OF THE INVENTION

Network servers provide the functions that were once provided by software executing on a local computer. Companies that own these servers, derive income from the users of these functions through subscription or license, and need to control and monitor the access to these functions by users. Network server based functions on the Internet have been given the name of “web services” where users and user system can access the functions using the Internet. The access to web services is usually through subscription but licenses or other forms of access control or sale can be used. The term subscription includes licenses and these other forms. Since all of the software of the function is on the server, traditional software distribution and license control technologies are not applicable to control the use of a function on a server. The prior art teaches that access to a system can be controlled by providing each user a means by which the user can be authenticated. A widely used authentication mechanism is the assignment of a unique user identifier for each users and a user created password. This mechanism is effective as long as the users protect their user identifiers and passwords from use by others. However, if the users do not protect their user identities and passwords, multiple users can use the same user identifier and password to access the server function. The server can protect against multiple accesses by the same user identifier by recording when a user identifier has started access to the system and completed access. If another instance of the same user identifier attempts to access the system during the start and completion by the initial instance, the server can detect that two users are using the user identifier. Once detected, the server can take appropriate action such as denying access to the second instance, preventing future access to the system by the user identifier, etc. However, this mechanism requires that the server determine when a user has log in and when the user has logged off. The server can provide explicit commands for the user to execute to log in and to log off. However, some users may forget to log off and leave the user identifier logged into the server. When the user tries to log in again, the server will detect this as a second access by the user identifier and deny access. The user can contact the server administrator to reset the user identifier and permit the user to access the system. This is an acceptable solution if the number of users who forget to log off is small. However, a server with a large number of users can experience a large number of users requesting their user identifiers be reset because they forgot to log off. The Internet poses another challenge where the connection to the server is not always available and a user who may have logged in may not be able to log off. So the number of Internet users requesting the server administrator to log them off can be large. It is desirable to provide a means by which users who have forgot to log off be able to connect back to the service. However, how does the server insure that the user who originally logged in is the same user and not a second instance attempting to use the service?

Internet users do not always use the same device to use the server function. A user may access using a workstation at work, or a cell phone, or a wireless personal digital assistant, or a PC from home. The ubiquity of the Internet and the diversity of the devices do not easily permit the use of special hardware in the device to identify the user.

If the period a user is active using the web service can be determined, the server can limit number of concurrent users by monitoring the number of active user identifiers. A web service owner can provide a subscription for a specified number of concurrent users even if there are a larger number of users with user identifiers.

The prior art user access controls are based on the authentication of users. The usual authentication mechanism is assigning each user a user identifiers and password.

However, there are processes for which the user authentication is not adequate and a different solution is needed. One process is used for the control and tracking of the manufacture of products on a manufacturing shopfloor. Shopfloor programs have been written for main frame computers, mini-computers, and client-server systems to record the location of an item of a product on a manufacturing line, compare the location with a predetermined location, and provide directions to operators and shopfloor equipment for operations on the item. The step-by-step operations for an item to be manufactured can be documented in a route. The route specifies the operation step and the location, the work center, at which the operation is to be performed. FIG. 1 illustrates a route where operation A is performed at Work Center 1, then operation B is performed at Work Center 2, and operation C is performed at Work Center 3. FIG. 2 illustrates a route where the terminals of a main frame or mini-computer shopfloor system or the client computers of a client-server shopfloor system are positioned at work centers to record the location of an item and to provide instructions to the operators or equipment at the work centers. The mainframe or mini-computer program has a table or other map of the terminals in relationship to the work centers. The client computer of a client-server shopfloor system has a program in the client computer where the program can been configured to be identified as a specific work center. The operators of these systems usually have user identifiers and passwords in the shopfloor system to authenticate the users. Operators log on and off the shopfloor system at the terminals or the client computers. “Operators log on to a work center” means that the operators log on to a terminal or computer that represents the work center in the shopfloor program. Since the map of terminals to work centers and the assignment of a client computer to a work center are static and the network of terminals and client computers are all connected by direct cables or a controlled local area network (LAN), the terminals or the client computers that serve as the work centers do not need to log in or log off. However, in a web service environment, the Internet device associated with a work center must be authenticated just as users must be authenticated and be associated with the work center. FIG. 3 illustrates a route where Internet devices are positioned at work centers. The Internet devices use the Internet to send information on an item at the work center to a shopfloor web service. The shopfloor web service responds with information with instructions to the operators and equipment at the work center to operate on the item. Operators log on to work centers by logging on the Internet device associated with the work center to the shopfloor web service using the Internet. The shopfloor web service associates the Internet device with the work center in the route. The Internet device cannot be associated with a specific user. A first operator may log in on the Internet device associated with a first work center. The shift may change and a second operator is now at the work center using the Internet device. The second operator may log off on the Internet device and the first work center. A third operator may log on the work center using the Internet device. The third operator may be qualified to operate a second work center and logs on to a second Internet device while the first Internet device is still active at the first work center. Internet devices are mobile and can move from a first work center to a second work center. The authentication mechanism must permit the Internet device to change work centers and the work centers to have different Internet devices. The number of active Internet devices associated with the set of work centers may be less than the number of work centers. This concept is similar to the concurrent user subscription. A manufacturing line may have work centers that are used infrequently or manufacturing lines that are not used all the time. This will permit a manufacturer to subscribe to the number of concurrent work center subscriptions needed rather than the total number of work centers. Note, each work center could be assigned a user identification and password but this would be rather cumbersome since the operators would have to log in as a work center first and then log in as the operator. Work center identifiers still does not permit an operator to be working at two work centers.

In addition, all operators may not be qualified to operate all work centers. Only specific operators may be qualified to operate a given work center. The work center authentication should provide a means to limit the operators permitted to operate a work center.

A shopfloor web service or similar web service where Internet devices are associated to elements of the web service other than operators, such as work centers, requires functions not provided by user authentication mechanisms. What is desired is a means for an Internet device to be authenticated and associated with a work center; that the means permit operators to log in and log off work centers; operators to change at a work center; operators to work at more than one work center; permit a first operator to log off a work center and a second operator to log on the work center; and a means to determine the number of active concurrent work center Internet devices. In addition, only permit specific operators log on a given work center. The Internet device provides limited functions. The functions are limited to protect the Internet device and the LAN to which it is connected from attack by hackers on the Internet. The authentication and association processes must be accomplished using the Internet device functions.

### BRIEF DESCRIPTION OF DRAWINGS

FIG. 1 illustrates route with work centers 1, 2, & 3.

FIG. 2 illustrates route with work centers 1, 2, & 3 with terminals or client computers at each work center.

FIG. 3 illustrates route with work centers 1, 2, & 3 with Internet devices at each work center

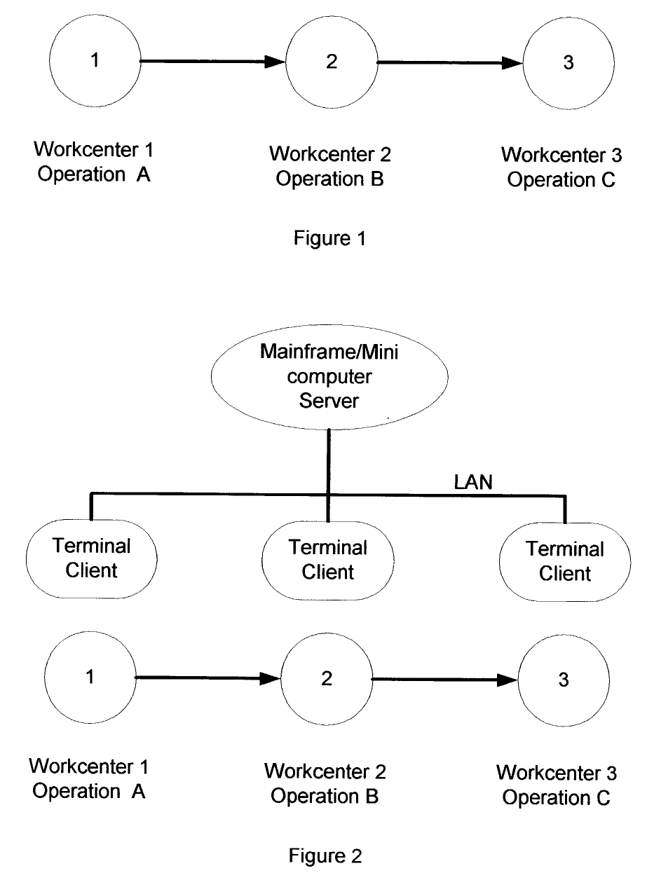

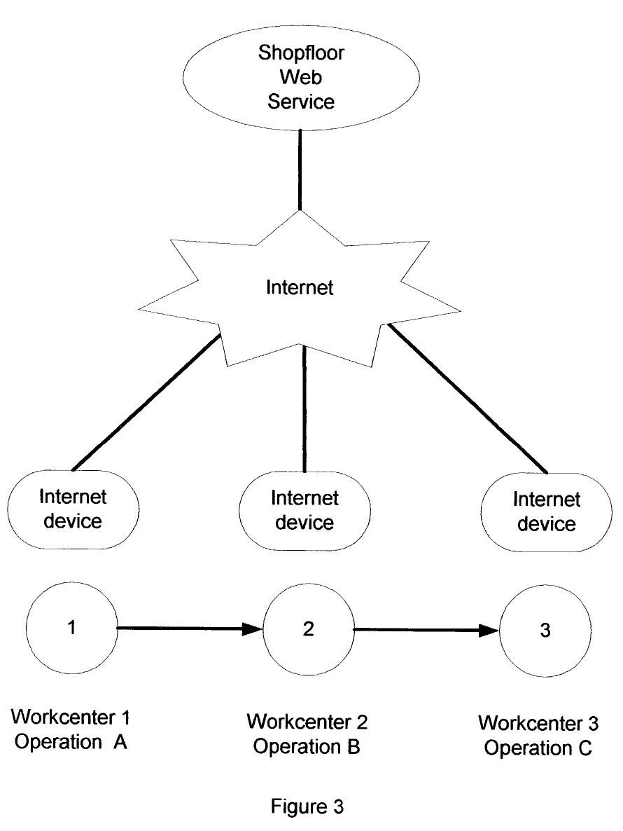

### DESCRIPTION OF THE INVENTION

The Work Center Subscription Web Server comprises five sets: Work centers, Internet devices, work center subscriptions, operators and operator subscriptions and can be an element of a web service such as a shopfloor web service. Work center are logical locations in a route in shopfloor system corresponding to physical locations. All Internet devices contain an Internet browser function and can be devices such as a personal computer, a cell phone, a wireless personal digital assistant, a workstation, a video game console, etc. An Internet device is connected to the Internet and can be associated with a work center. Each operator has a user identifier and password to authenticate the user. The customer of the Work Center Subscription Web Server service subscribes to a first number of work center subscriptions and a second number of operator subscriptions. The first number is the maximum number of concurrent active work centers and the second number is the maximum number of concurrent active operators. A first operator logs in on an Internet device using the first operator's user identifier and password. The Work Center Subscription Web Server authenticates the operator's identifier and password. This logs in both the operator and the Internet device and requires a work center subscription and an operator subscription. If the Internet device is not associated with a work center, the operator selects a work center from the set of work centers. The Internet device is now associated with the work center and the first operator is logged onto the work center. A second operator uses a change operator function on the Internet device and the second operator uses the second operator user identification and password to replace the first operator and the first operator subscription is released and the second operator uses an operator subscription. The work center continues to be logged on. The second operator can change the work center associated with the Internet device using a change work center function where a second work center is selected from the set of work centers. The second operator can log off both the operator and the Internet device from the work center. The operator subscription and the work center subscription are released. The Internet device is still associated with the work center. A third operator logs in on the Internet device using the third operator user identification and password. The log in requires an available work center subscription and an available operator subscription. The Internet device is still associated with the work center assigned by the second operator so the association process is not needed when the third operator logged in. The third operator can log in on a second Internet device at a second work center using the third operator user identifier and password. Another available workcenter subscription is required for the second Internet device but another operator subscription is not required since the third operator is already using an operator subscription. The authentication process distinguishes between the operator and work center subscriptions. The authentication process uses the authenticated operator to log in the Internet device so that it can be associated with a work center.

If the work center is left logged on and a fourth operator attempts to log in on the same Internet device, the subscription is still in use and the work center continues to be logged on. If an operator logs in using another Internet device, another work center subscription is used since the first Internet device is still using the first work center subscription. When the Internet device is logged off, the work center subscription is released and can be used by another device.

If the number of work center subscriptions used is equal to the number of work center subscriptions available, then all other log in by operators using Internet devices without a work center subscription will be denied. Similarly, if the number of operator subscriptions used is equal to the number of operator subscriptions available, then all other log in by operators without an operator subscription will be denied. If the number of operator subscriptions equals the number of operators, then the concurrent user subscription degenerates into a “named user” subscription where each operator has a subscription. The work center subscription may be more complicated since it may be desirable for a work center to have more than one Internet device associated with the work center. The ability to provide increased capacity with multiple Internet devices would be one reason. However, it is possible to map work center subscriptions to work centers or to Internet devices and constrain the use similar to the constrained mapping of named users for operators. The work centers may be assigned identifiers and passwords independent of the operators and accomplish these functions. However, this is another set of identifiers and passwords that the operators must remember. In practice, these identifiers and passwords would probably be posted on the Internet devices and not of significant authentication or security value.

Each operator can be assigned a list of work centers at which the operator can work. When an operator logs using an Internet device, the work center associated with the Internet device is compared with the list of work centers for the operator. If the associated work center is in the list, the operator is permitted to log in. If the associated work center is not in the list, the operator is denied the log in. If the work center is not associated with a work center, the list of work centers from which the operator can select is from the list of work centers assigned to the operator.

The shopfloor web service is used to illustrate the present invention. The present invention can be applied to other services such as package delivery, baggage distribution, warehousing, bank tellers, market check out registers, etc. Services where devices are not fixed in relationship to the system object (such a work center) and multiple operators can use the devices are candidates for application of the present invention. The authenticated user is used to associate the device with the system object. The log in and log out by operators can be used to determine the active use of the system object and the maximum concurrent active use of the system object can be controlled.

Description of a Preferred Embodiment

The Work Center Subscription Server uses the functions available in Internet web browsers and web servers. Tables in a relational database are used to store information related to the work center subscriptions, the associated work centers and the work centers associated with each operator. The operator user identifiers and passwords are also stored in a table illustrated as Table 1 Operator Table.

TABLE 1
Operator Table

| Operator Identifier | Operator Password |
|---|---|
| Operator 1 | Abc10t+ |
| Operator 2 | Def89#* |
| Operator 3 | Ghj03$k |
| Operator 4 | Hjk63#) |

The operator accesses the Work Center Subscription Web Server using an Internet device. The interface is web pages provided by a web server component in the Work Center Subscription Web Server. The first page is a familiar log in page with a text entry fields for the Operator Identifier and the Operator Password. The operator with the identifier Operator 1 enters Operator 1 as the Identifier and Abc10t+ as the password and submits the page to the web server. A work center subscription program at the Work Center Subscription Web Serve accesses the Operator Table and determines that the Operator Identifier is in the table and that the Operator password matches the password submitted in the page. The program then determines if an Operator subscription is available by querying the Operator Subscription Table illustrated as Table 2. If available, the program inserts the Operator Identifier and time stamp into the Operator Subscription Table. This indicates that the Operator subscription is used. The Operator Subscription Table illustrated has a maximum of two operator subscriptions where one is used and one is available. If both Operator subscriptions were already in use, Operator 1 would be given a screen indicating that all of the subscriptions were in use. In some applications the number of Operator subscription is not limited and the Operator Subscription Table and processes are not required.

TABLE 2
Operator Subscription Table

| Operator | Time Stamp |
|---|---|
| Operator 1 | Aug. 30, 2002 16:43:21 |
| Available | |

The work center subscription program retrieves the cookie on the Internet device and determines that the Internet device is not associated with a work center. The program access the Work Center Operator Table illustrated as Table 3 using Operator 1 as the select argument against the Operator field. The query returns Work Center 1 and Work Center 2 as the work centers at which Operator 1 can work. The Work Center Operator Table also indicates that Operator 2 can work at Work Center 2, that Operator 3 can work at Work Center 2 and Work Center 3, and that Operator 4 can work at Work Center 2. In this example, Operator 1 selects Work Center 1.

TABLE 3
Work Center Operator Table

| Work Center | Operator |
|---|---|
| Work Center 1 | Operator 1 |
| Work Center 2 | Operator 1 |
| Work Center 2 | Operator 2 |
| Work Center 2 | Operator 3 |
| Work Center 3 | Operator 3 |
| Work Center 2 | Operator 4 |

The work center subscription program then determines if a work center subscription is available by querying the Work Center Subscription Table illustrated as Table 4. If a work center subscription is available, the work center and a time stamp are inserted into the table to indicate that a subscription is used. Note that the maximum number of work center subscriptions in the example is two and that one other work center subscription is still available.

TABLE 4
Work Center Subscription Table

| Work Center | Time Stamp |
|---|---|
| Work Center 1 | Aug. 30, 2002 16:43:25 |
| Available | |

The work center subscription program then writes a cookie on the Internet device with the work center, Work Center 1 and the time stamp, 8/30/02 16:43:25. The work center is to indicate the work center with which the Internet device is associated and the time stamp is used to distinguish the cookie from other cookies that may be on other Internet devices with the same work center. Recall that more than one Internet device may be associated with a work center or the Internet device may have a cookie with Work Center 1 from a previous connection but not erased because the Internet device did not log off. More on this later. The time stamp or other distinguishing information is included in the cookie. To continue with the example, Operator 2 replaces Operator 1 and the Internet device has been moved to Work Center 2. The Change Operator function is a web screen where the work center subscription program logs Operator 1 off the system by removing Operator 1 and the time stamp from the Operator Subscription Table and marking the row as Available. Operator 2 logs in using the Operator 2 user identifier and password. The work center subscription program queries the Operator Table and validates the identifier and password. The program then queries the Operator Subscription Table to determine if an Operator subscription is available. Two operator subscriptions were available and Operator 2 and the time stamp are stored in the Table. The program retrieves a copy of the cookie on the Internet device and determines that it is associated with Work Center 1. The time stamp in the cookie is compared with the time stamp in the table to determine that the work center and Internet device are associated with each other. The program then accesses the Work Center Operator Table and determines that Operator 2 cannot operate Work Center 1. The program then provides the list of work centers at which Operator 2 can operate, Work Center 2 Operator 2 selects Work Center 2. The program updates the Work Center Subscription Table with Work Center 2 and the current time stamp. A cookie with Work Center 2 and the time stamp stored in the table is sent to the Internet device.

Operator 2 completes the process step at Work Center 2 and logs off the system. The log off operation clears the entries for Operator 2 from the Operator Subscription Table and Work Center 2 and time stamp from the Work Center Subscription Table.

Operator 3 logs in using the Internet device. The work center subscription table determines that an operator subscription is available and inserts Operator 3. The program then retrieves a copy of the cookie and determines that the work center associated with the Internet device is Work Center 2, a work center subscription is available and Operator 3 can work at Work Center 2. The program inserts Work Center 2 and the time stamp in the Work Center Subscription Table and sends a cookie to the Internet device with Work Center 2 and the time stamp. Operator 3 only sees that the log in at Work Center 2 was successful. The cookie on the Internet device with Work Center 2 avoided the work center selection process.

Operator 3 is assigned to Work Center 3 but has not logged off of the Internet device associated with Work Center 2. Operator 3 logs in on the Internet device associated with Work Center 3. The work center program determines that Operator 3 is already using an Operator Subscription and does not change any thing in the Operator Subscription Table. The work center subscription program retrieves a copy of the cookie on the Internet device at Work Center 3 and determines that the Internet device is associated with Work Center 3 but not logged on. The program determines that a work center subscription is available and inserts Work Center 3 and the time stamp in the Work Center Subscription Table and writes a cookie to the Internet device with Work Center 3 and the time stamp. To Operator 3, the log on to Work Center 3 was successful. The cookie on the Internet device at Work Center 3 avoided the work center selection process.

Operator 4 is assigned to Work Center 2. Recall that Operator 3 had not logged off. But someone had turned off the Internet device and Operator 4 turns the Internet device on and attempts to log in using the Operator 4 identifier and password. The work center subscription program determines that an Operator subscription is available and enters Operator 4 and the time stamp in the Operator Subscription Table. The program retrieves a copy of the cookie from the Internet device and compares the work center and time stamp with the fields in the Work Center Subscription Table. These match a table entry that indicates that Work Center 2 is already logged in and that nothing more needs to be done. Operator 4 experiences a successful log in. The fact that the Internet device had been turned off and that the log in recovered the work center subscription and the work center association was invisible to the user.

All of the operator subscriptions are used. If Operator 1 or Operator 2 tries to log in, the operator would receive a response indicating that all of the operator subscriptions are in use and the operator cannot log in to a work center. All of the work center subscriptions are used. If Operator 3 or Operator 4 tries to log in using another Internet device, the operator would receive a response indicating that all the work center subscriptions are in use and cannot log into another work center.

There may be error situations where the Work Center Subscription Table has recorded a work center and time stamp and the Internet device with the cookie is not capable of logging on and logging off to delete the entry in the table. In this condition, an error recovery program is used to set the table entry to available.

The work center subscription program is implemented as software written in Java, C++, Visual Basic, or a number of programming languages provided by Microsoft, IBM, BEA, and others. The program may use a relational database for storing the tables other information. Database programs are available from Oracle, IBM, Microsoft, and many other providers. Microsoft, Netscape, and others provide the Internet web server programs. These programs and databases execute in computers manufactured by, for example, IBM, Sun, Dell, and Compaq. The computers may be, for example, PC's, workstations, mainframes, and hand-held computers. The computers may have an operating system such as UNIX, LINUX, Microsoft 2000, and IBM OS/9000. The computers are connected to a network that may be, for example, a LAN, WAN, Internet, Intranet, wireless LAN, or wireless Internet. The Internet devices can be PC's, workstations, cell phones, personal digital assistants, wireless Internet adapted devices, video game consoles, and an expanding set of devices.

The Work Center Subscription Web Server provides a means by which operators can log on using an Internet device and also log on and associate the work center with the Internet device. The operators may change after the work center is logged on. Operators may change the work center associated with an Internet device. The Internet device retains the work center association after the Internet device is logged off. The Internet device retains the work center subscription after a power off or other disconnection if the Internet device has not been logged off. These functions are invisible to the operators who just log in to work centers using their user identification and passwords using the Internet device connected to the Internet.

I claim:

1. A Work Center Subscription Web Server and an Internet device, both connected to the Internet; a first operator; wherein the Work Center Subscription Server contains data for a first work center and a work center subscription and the operator uses the Internet device to log into the Work Center Subscription Web Server; the operator selects the first work center, and the Work Center Subscription Web Server assigns a work center subscription to the Internet device and first work center, associates the Internet device with the first work center; and the first operator is logged into the first work center.

2. The Work Center Subscription Web Server of claim 1 wherein the operator is authenticated when logging in.

3. The Work Center Subscription Web Server of claim 1 and a second work center wherein the operator associates a second work center with the Internet device and work center subscription to replace the first work center.

4. The Work Center Subscription Web Server of claim 1 wherein the Work Center Subscription Web Server sends a message with the first work center and a unique identifier to be recorded in the Internet device.

5. The Work Center Subscription Web Server of claim 1 wherein the Work Center Subscription Web Server receives a message containing the first work center identifier and a unique identifier from the Internet device to determine the work center associated with the Internet device.

6. The Work Center Subscription Web Server of claim 1 wherein Work Center Subscription Web Server receives a message containing the first work center identifier and a unique identifier from the Internet device to determine the work center subscription associated with the Internet device.

7. The Work Center Subscription Web Server of claim 1 wherein the operator logs off the work center using the Internet device, releasing the work center subscription.

8. The Work Center Subscription Web Server of claim 1 wherein the operator selects a work center from a list of work centers for which the first operator is authorized.

9. The Work Center Subscription Web Server of claim 1 wherein the Work Center Subscription Web Server provides a maximum number of work center subscriptions and the operator logs into the first work center if the number of work center subscriptions assigned is less than or equal to the maximum number of work center subscriptions.

10. A Work Center Internet Device; a Work center subscription server containing data on a work center and a work center subscription; both connected to the Internet; an operator wherein the operator uses the Work Center Internet Device to log onto the Work center subscription server and selects the work center, and the work center subscription is assigned to the Work Center Internet Device and the work center; the work center is associated with the Work Center Internet Device and the operator is logged into the first work center.

11. The Work Center Internet Device of claim 10, wherein the first operator is authenticated when logging in.

12. The Work Center Internet Device of claim 10 and a second work center, wherein the second work center is associated with the Work Center Internet Device and work center subscription replacing the first work center.

13. The Work Center Internet Device of claim 10, wherein the Work Center Internet Device receives a message containing the first work center identifier and a unique identifier from the Work center subscription server and stores the message.

14. The Work Center Internet Device of claim 10, wherein the Work Center Internet Device sends a message containing the first work center identifier and a unique identifier to the Work center subscription server to determine the work center and work center subscription associated with the Work Center Internet Device.

15. The Work Center Internet Device of claim 10, wherein the operator uses the Work Center Internet Device to log off the work center and releases the work center subscription.

16. A Work Center Service; a Internet device, both connected to the Internet; an operator; a first work center wherein the Work Center Service provides a maximum number of work center subscriptions and the operator uses the Internet device to log into the Work Center Service and if the number of work center subscriptions is less than or equal to the maximum number of work center subscriptions, the first work center is assigned a work center subscription, the internet device is associated with the first work center, and the operator logs into the first work center.

17. The Work Center Service of claim 16 wherein the operator logs off the first work center releasing the work center subscription.

18. The Work Center Service of claim 16 wherein the operator is authenticated when logging in.

19. The Work Center Service of claim 16 and a second work center, wherein the operator selects the second work center to associate with the Internet device and work center subscription to replace the first work center.
